(19) United States
(12) Patent Application Publication
(10) Pub. No.: US 2012/0327316 A1
(43) Pub. Date: Dec. 27, 2012

(54) PROJECTION DISPLAY DEVICE

(76) Inventors: Takayuki Okada, Tokyo (JP); Yoshifumi Nishimura, Tokyo (JP)

(21) Appl. No.: 13/583,149

(22) PCT Filed: Mar. 11, 2010
(86) PCT No.: PCT/JP2010/054107

§ 371 Date: Sep. 6, 2012

(51) Int. Cl. H04N 5/74

(52) U.S. Cl. 348/748; 348/E05.137

(57) ABSTRACT

Disclosed is a projection display device that modulates light emitted from a light source by a video device to project it. The projection display device includes: a heat sink including a plurality of fins on a rear surface side; the video device disposed on the front surface side of the heat sink to be thermally connected to the heat sink; a centrifugal fan that sucks air through spaces between the plurality of fins included in the heat sink; and a first duct that guides the air discharged from the centrifugal fan to the light source.

### TECHNICAL FIELD

The present invention relates to a projection display device, and more particularly to a cooling structure for cooling a light source, a device or an element mounted on the projection display device.

### BACKGROUND ART

The projection display device at least includes an electronic device (video device) that spatially modulates light emitted from the light source based on a video signal, and an optical system that magnifies and projects the modulated light to a screen. Such video devices are largely classified into a transmissive device and a reflective device. A MID (digital mirror device) is a representative example of the reflective video device used for the projection display device of a DLP (digital light processing (registered trademark)) type.

During the operation of the projection display device, the temperature of the reflective video device increases due to irradiation with strong light. This necessitates a cooling structure for maintaining the temperature of the video device equal to or lower than a predetermined temperature. Patent Literatures 1 to 3 described below disclose cooling structures for video devices relating to the present invention.

Patent Literature 1 discloses the cooling structure of a liquid cooling type. The cooling structure disclosed in Patent Literature 1 includes at least a cooling unit disposed on the rear surface of the video device, a radiator, and cooling liquid circulated between the cooling unit and the radiator. The cooling liquid absorbs the heat of the video device via the cooling unit, and discharges the absorbed heat by heat exchanging at the radiator. The cooling structure disclosed in Patent Literature 1 uses a basic liquid cooling technology. The cooling structure disclosed in Patent Literature 1 has long been used for cooling the CPU of an electronic computer.

Patent Literature 2 discloses a cooling structure that uses an electronic cooling element. The cooling structure disclosed in Patent Literature 2 includes at least the electronic cooling element disposed on the rear surface of the video device, a heat sink disposed on the rear surface (waste heat surface) of the electronic cooling element, and an axial fan disposed behind the heat sink. The cooling structure disclosed in Patent Literature 2 increases the cooling efficiency of the electronic cooling element by blowing air discharged from the axial fan to the heat sink.

Patent Literature 3 discloses an air cooling type cooling structure. The cooling structure disclosed in Patent Literature 2 includes a blower that serially cools two heat generation components. Air discharged from the blower is guided to the heat sink that is thermally connected to the video device via a first duct. The air that has been guided to the heat sink absorbs the heat of the video device via the heat sink. The air that passed through the heat sink is guided to a color wheel motor and a light tunnel via a second duct to cool the color wheel motor and the light tunnel.

### CITATION LIST

### Patent Literature

Patent Literature 1: JP2004-333526A
Patent Literature 2: JP2000-338603A
Patent Literature 3: JP2009-134201A

### SUMMARY OF INVENTION

### Problems to be Solved by Invention

However, the cooling structures disclosed in Patent Literatures 1 to 3 respectively have the following problems.

The cooling structure disclosed in Patent Literature 1 further needs a pump to circulate the cooling liquid or a tube to form a flow path. Each connection portion on the flow path must be sealed to prevent leakage of the cooling liquid. Further, liquid leakage detection means must be provided just in case liquid leakage occurs. As a result, this causes an increase in the size and weight of the system. The cooling liquid deteriorates and decreases with time, and thus replacement or replenishment of the cooling liquid is necessary.

The cooling structure disclosed in Patent Literature 2 uses an electronic cooling element that discharges heat, which is absorbed from a heat absorption side of the electronic cooling element, from a heat discharge side of the electronic cooling element. To increase the cooling effect of the electronic cooling element of this type, the waste heat surface must be sufficiently cooled. This necessitates high-speed rotation of the axial fan disposed behind the heat sink, thus increasing noise and vibration.

In the cooling structure disclosed in Patent Literature 3, heat exchanging at the heat sink causes an increase in the temperature of the cooling air which is supplied to the color wheel motor and the light tunnel. Thus, the temperature difference between the color wheel motor and the light tunnel and the cooling wind is reduced, lowering the cooling effect. To begin with, the amount of generated heat at the color wheel and the light tunnel is small, and temperature increases are limited. As a result, when the temperature of the cooling air increases about 10° C. due to heat exchanging at the heat sink, the temperature difference between the cooling air and the color wheel and the light tunnel is greatly reduced, lowering the cooling effect.

### Solution to Problem

A projection display device, which modulates light emitted from a light source by a video device to project it, includes: a heat sink thermally connected to the video device; a centrifugal fan that sucks air through spaces using a plurality of fins included in the heat sink; and a first duct that guides the air discharged from the centrifugal fan to the light source.

### Effects of Invention

According to the present invention, at least one of the problems is solved.

### BRIEF DESCRIPTION OF DRAWINGS

FIG. 1 is an appearance perspective view showing a projection display device according to the first exemplary embodiment of the present invention;

FIG. 2 is an exploded perspective view showing the projection display device according to the first exemplary embodiment of the present invention;

FIG. 3 is an enlarged perspective view showing a lamp unit and an optical engine;

FIG. 4 is an enlarged perspective view showing a DMD unit and a heat sink;

FIG. 5 is a perspective view showing a cooling structure mounted on the projection display device according to the first exemplary embodiment of the present invention;

FIG. 6 is an exploded perspective view showing the cooling structure mounted on the projection display device according to the first exemplary embodiment of the present invention;

FIG. 7 is a perspective view showing the fixed structure of a sirocco fan and a heat sink in a projection display device according to the second exemplary embodiment of the present invention;

FIG. 8 is an enlarged sectional view showing in detail the fixed structure shown in FIG. 7;

FIG. 9 is a perspective view showing a cover in a projection display device according to the third exemplary embodiment of the present invention;

FIG. 10 is a perspective view showing one modified embodiment of the cover to cover the heat sink; and

FIG. 11 is a perspective view showing a projection display device that includes a third duct.

### DESCRIPTION OF EXEMPLARY EMBODIMENTS

### First Exemplary Embodiment

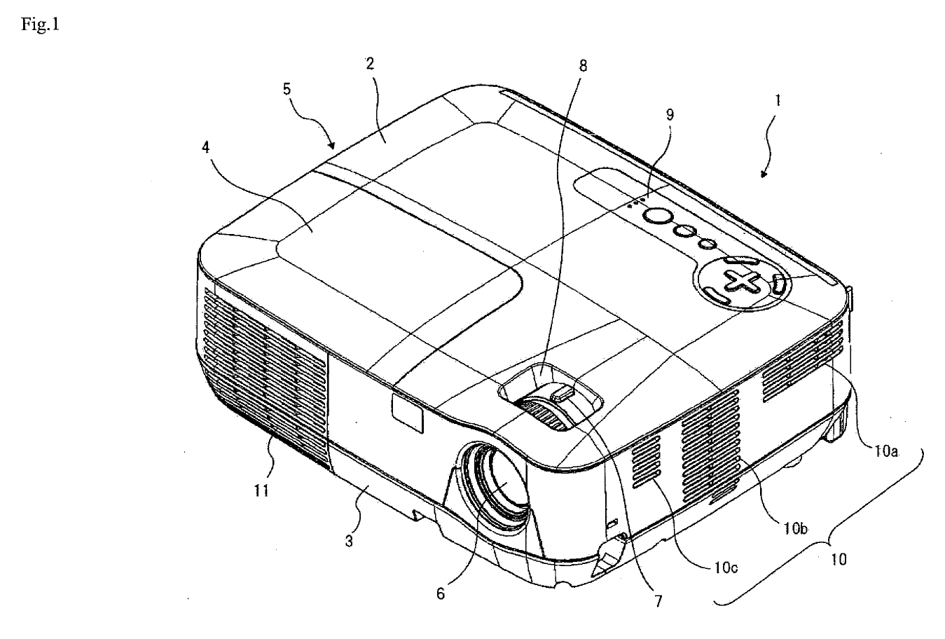

FIG. 1 is an appearance perspective view showing projection display device 1 according to the first exemplary embodiment of the present invention. Projection display device 1 includes case 5 that includes upper case 2, lower case 3, and lamp cap 4. On the upper surface of case 5, there are arranged concave portion 8 to expose lever 7 for adjusting a zoom and a focus of projection lens 6, and operation panel 9 for operating device 1. Suction ports 10 (10a to 10c) are formed on the left side face of case 5, and two suction ports (not shown) are formed on the right side face. Exhaust port 11 is formed on the front face of case 5.

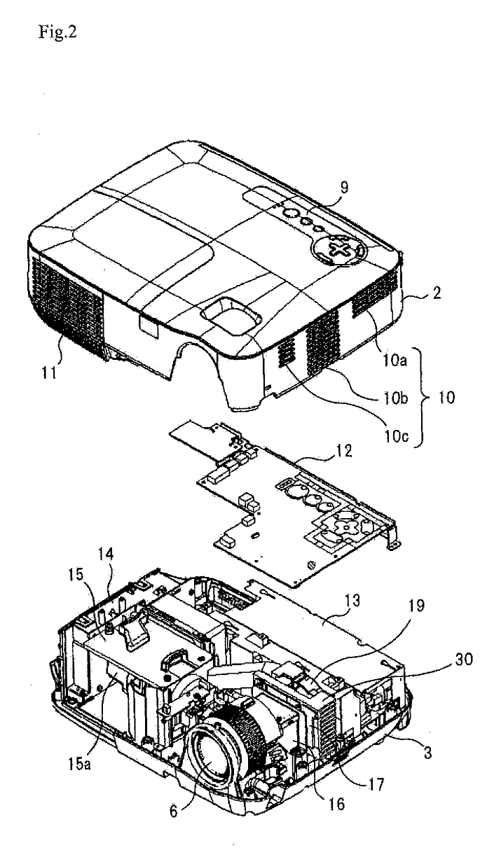

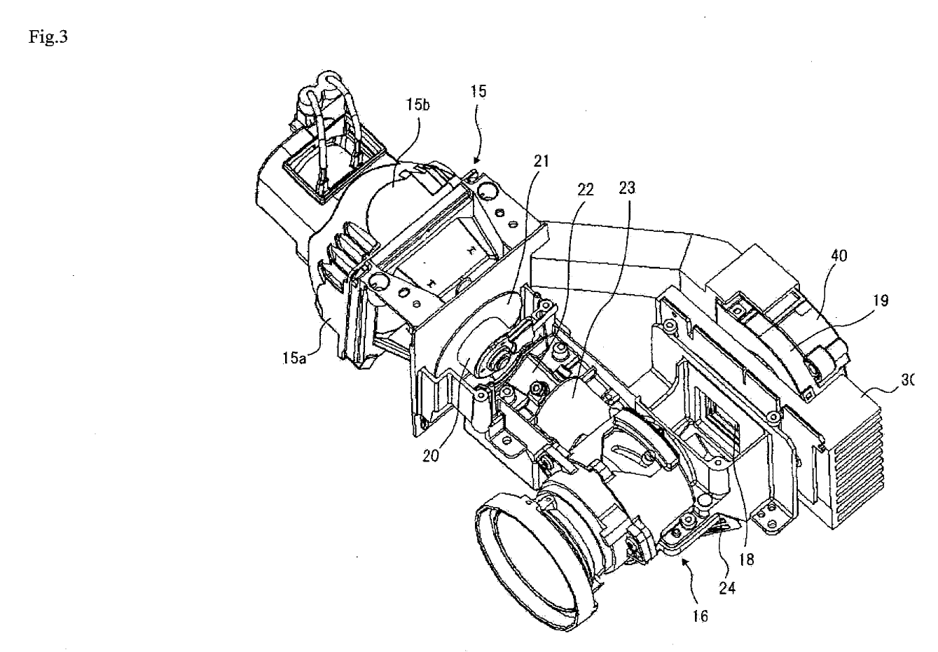

FIG. 2 is an exploded perspective view showing projection display device 1. In FIG. 2, upper case 2 and main substrate 12 are removed. When a power button on operation panel 9 is pressed, projection display device 1 is activated. After projection display device 1 has been activated, lamp 15a in lamp unit 15 is stably lit by blast 14. Light emitted from lamp 15a enters optical engine 16 to be applied to DMD 18 (FIG. 3) in DMD unit 17 via a plurality of optical components (not shown) in optical engine 16. DMD 18 is driven according to a video signal generated on main substrate 12, and selectively reflects the applied light to generate a video. The generated video is magnified and projected to a screen (not shown) via projection lens 6.

During the series of operations, the temperature of the electronic component or the optical component increases due to self-generated heat or light absorption. Thus, projection display device 1 of this exemplary embodiment includes an axial fan (not shown) disposed in the center of the case, and a centrifugal fan (sirocco fan 19) disposed behind DMD unit 17.

The axial fan introduces external air from suction port 10 which is disposed on the side of case 5 into case 5. Power source unit 13, main substrate 12, DMD unit 17 and blast 14 are cooled by air introduced into case 5 by the axial fan. Further, the air that is exhausted from the axial fan is supplied to lamp unit 15 to cool the outer surface of reflector 15b (FIG. 3). The air that has cooled the outer surface of reflector 15b is discharged from exhaust port 11 of the front of case 5 to the outside.

FIG. 3 is a perspective view showing lamp unit 15 and optical engine 16. Light emitted from lamp unit 15a is passed through color wheel 21 driven to rotate by motor 20, and then through light tunnel 22 and condenser lens unit 23 to enter a mirror (not shown) attached to reflection mirror attaching portion 24. Condenser lens unit 23 includes two condenser lenses (not shown). The light that has entered condenser lens unit 23 sequentially passes through the two condenser lenses. The light that has entered the mirror is reflected by the mirror to be applied to DMD 8 via a third condenser lens. The light irradiation then causes the temperature increase of DMD 18. Much of the heat of DMD 18 moves to heat sink 30 disposed behind DMD 18.

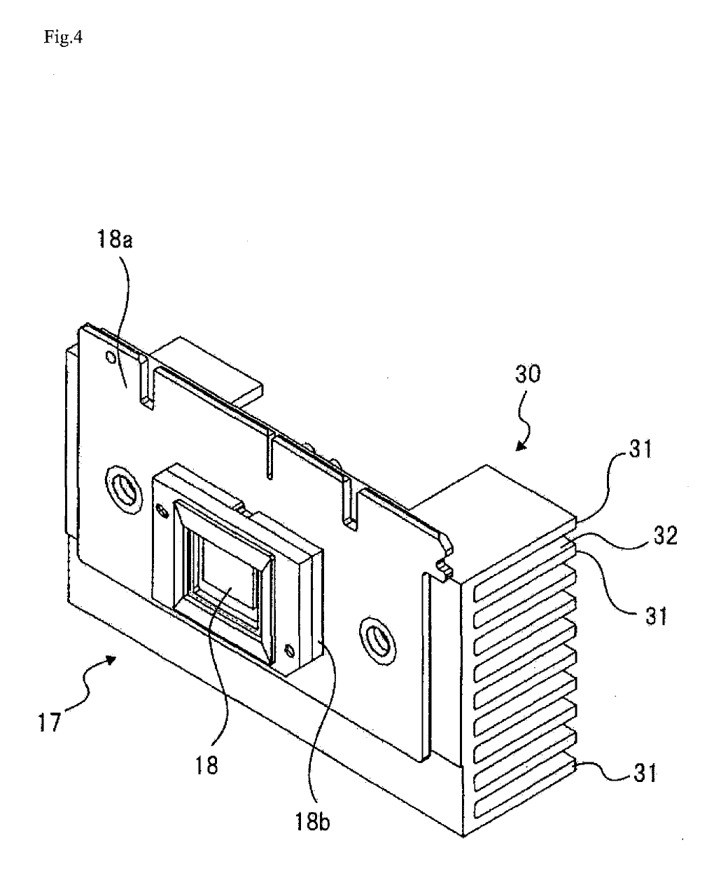

As shown in FIG. 4, DMD 18 is inserted into socket 18b mounted on DMD substrate 18a, and heat sink 30 is located behind DMD substrate 18a. The rear surface of DMD 18 is connected to head sink 30 via an opening (not shown) formed in DMD substrate 18a, and most of the heat of DMD 18 moves to the heat sink 30. In other words, DMD 18 and heat sink 30 are thermally interconnected. The heat that has moved to heat sink 30 reaches air (cooling air) that passed through space 32 between adjacent fins 31. In other words, most of the heat of DMD 18 is radiated in air via heat sink 30. Thus, DMD 18 is effectively cooled by effectively cooling heat sink 30. To effectively cool heat sink 30, low-temperature and fast cooling air must be supplied to the entire heat sink.

However, the conventional projection display device has included no means to forcibly supply cooling air to the heat sink. The heat sink has been cooled by the flow of air that is generated in the case by the operation of a fan corresponding to the axial fan. However, the temperature in the case is higher by 5 to 10° C. than the ambient temperature. The flow of air generated in case 5 is very weak. Thus, it has been difficult to effectively cool the heat sink. To maintain the temperature of the DMD equal to or lower than a predetermined temperature, therefore, the number of revolutions of the fan must be increased to increase the amount of air flowing in the case, thereby achieving a high speed. As a result, noise is increased, and the lamp is excessively cooled such that it generates flicker.

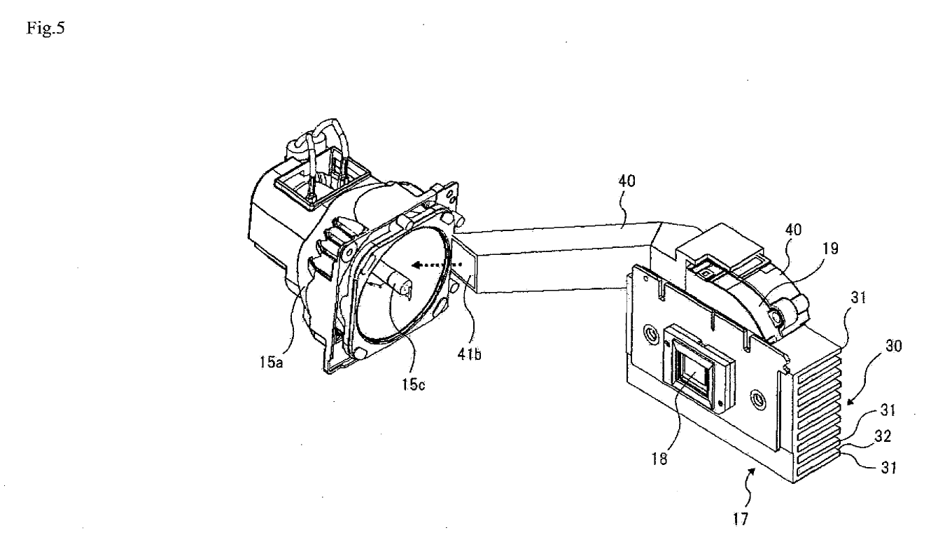

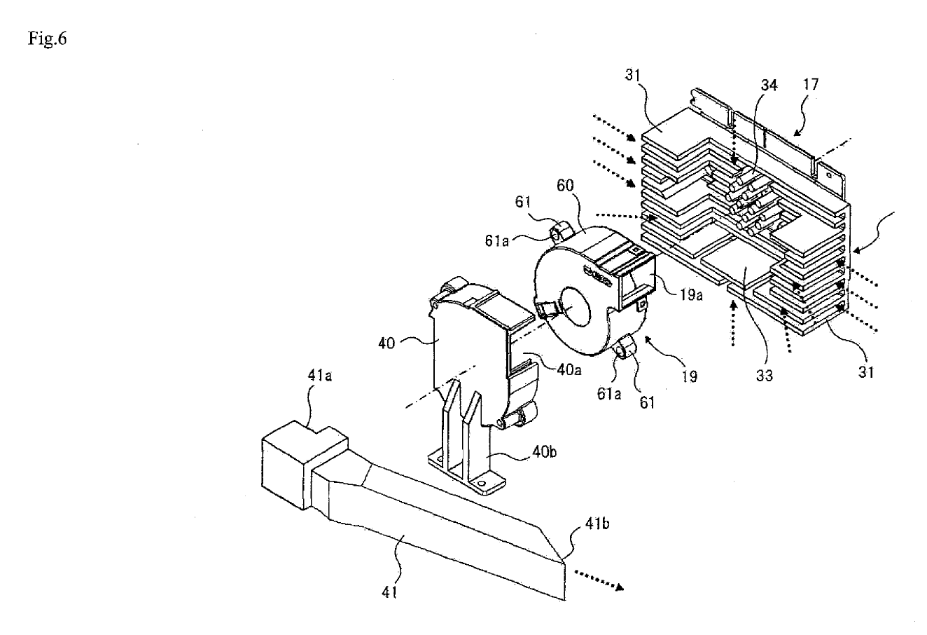

On the other hand, projection display device 1 according to this exemplary embodiment includes the following cooling structure. As shown in FIGS. 5 and 6, heat sink 30 is disposed behind the DMD unit 17, and sirocco fan 19 is disposed behind heat sink 30. In the description, the side of heat sink 30 opposite DMD unit 17 is defined as “front side”, while the opposite side is defined as “rear surface side”. However, these definitions are only for convenience.

As shown in FIG. 6, on the rear surface side of heat sink 30, many fins 31 are integrally formed to enlarge the surface area. Each fin 31 horizontally extends to be vertically stacked. Further, the end surfaces of rear surface sides of some fins 31 are partially concaved (retracted) toward the front surface side. As a result, concave installation space 33 is formed roughly in the center of the rear surface side of the heat sink. Sirocco fain 19 is housed in installation space 33 in a direction where a suction port (not shown) faces heat sink 30, and is covered with fan cover 40. In other words, sirocco fan 19 is disposed in heat sink 30.

Columnar heat discharge portions 34 are integrally formed in installation space 33 of heat sink 30. The leading end of each heat discharge portion 34 is inserted into the suction port of sirocco fan 19. The function and purpose of fin 31 and heat discharge portion 34 is to increase the surface area of heat sink 30 in order to increase cooling efficiency. Heat discharge portion 34 is formed in the shape of a pillar or column to prevent blocking of the flow of air near the suction port of sirocco fan 19 as much as possible.

On the side face of fan cover 40, there is formed opening 40a that is connected to exhaust port 19a of sirocco fan 19. In fan cover 40, stem 40b is integrally formed to extend downward. Stem 40b is screwed to lower case 3 (FIG. 2). Further, entrance 41a of first duct 41 is connected to opening 40b of fan cover 40, while exit 41b of first duct 41 is disposed near luminous tube 15c of lamp 15a. Fan cover 40 and first duct 41 are separately made of polycarbonate resins.

When sirocco fan 19 rotates, air around heat sink 30 passes through spaces 32 between fins 31 to be sucked through the suction port of sirocco fan 19. Heat sink 30 is cooled by the cooling air that passed through spaces 32. Further, since the space (space 32) between adjacent fins 31 is narrow, namely, 3 millimeters, the flow rate of the cooling air increases during passage through spaces 32. In other words, the cooling air of a high flow rate is forcibly supplied to the entire heat sink. Since the air around heat sink 30 is sucked from the inside of heat sink 30, even when ventilation resistance is high among fins 31, the cooling wind can surely be introduced between fins 31. As a result, by arranging fins 31 more densely, the cooling effect can be further improved.

The cooling air discharged from exhaust port 19a of sirocco fan 19 flows into first duct 41 via opening 40a of fan cover 40. The cooling air that has flown into first duct 41 is blown from exit 41b formed near luminous tube 15c of lamp 15a to cool luminous tube 15c.

Heat exchanging at heat sink 30 causes an increase in the temperature of the cooling air that is supplied to luminous tube 15c. Specifically, the temperature of the cooling air after passage through heat sink 30 is higher by 3 to 5° C. than before passage through heat sink 30. However, the temperature of DMD 18 (heat sink 30) is much lower than that of luminous tube 15c. Specifically, the temperature of the light emitting portion of luminous tube 15c is around 900° C., whereas the temperature of electrodes located on both sides of the light emitting portion is 200 to 400° C. Thus, luminous tube 15c can sufficiently be cooled by the cooling air passed through heat sink 30.

From the standpoint of reducing the ventilation resistance of first duct 41, it is desirable for duct 41 to be linear as much as possible. For example, in the cooling structure disclosed in Patent Literature 3, the flow path of the cooling air is bent by 90 degrees at two places, and thus ventilation resistance is high. It is desirable that exhaust port 19a of sirocco fan 19 and the section of first duct 14 be equal or similar in area and shape. For example, in the cooling structure disclosed in Patent Literature 3, the sectional area of a fan duct is much larger than the area of the supply opening of the blower. In other words, the sectional area of the flow path of the cooling air suddenly increases in the midway, and thus pressure loss occurs to increase ventilation resistance.

In the cooling structure according to this exemplary embodiment, since DMD 18 and lamp 15a are serially cooled, the increase/decrease in the number of revolutions of sirocco fan 19 roughly matches the increase/decrease of the temperature of DMD 18 and lamp 15c. Thus, it is desirable to set the number of revolutions of sirocco fan 19 so that the lamp temperature can be maintained within a predetermined temperature range (890 to 910° C.) and then set the size or shape of heat sink 30 so that the temperature of DMD 18 can be equal to or lower than a permissible temperature (65° C.).

To reduce the influence of a change in the temperature of the air that is introduced into case 5, a control unit that increases/decreases the number of revolutions of sirocco fan 19 according to the change of the ambient temperature is provided. The control unit controls the number of revolutions of sirocco fan 19 based on the information of a temperature detected by a temperature sensor (e.g., thermistor) disposed on main substrate 12 (FIG. 2) located near DMD unit 17. The temperature detected by the temperature sensor changes according to the change of the ambient temperature. Specifically, a memory on main substrate 12 stores data that indicates the relationship between the information of the temperature detected by the temperature sensor and the number of revolutions of the fan. The control unit refers to the data based on the information of the temperature detected by the temperature sensor, and controls the number of revolutions of sirocco fan 19 based on the reference result. As a result, even when the ambient temperature changes between 10 to 35° C., the temperature of the light emitting portion of luminous tube 15c is maintained within the range of 890 to 910° C., and the temperature of DMD 18 is maintained equal to or lower than 65° C. The control of the number of revolutions of sirocco fan 19 can prolong the lives of lamp 15a and DMD 18. The control unit can control not only sirocco fan 19 but also the axial fan. In this case, the memory stores data that indicates the relationship between the information of the temperature detected by the temperature sensor and the number of revolutions of sirocco fan 19, and the relationship between the information and the number of revolutions of the axial fan.

In place of sirocco fan 19, another centrifugal fan (e.g., turbofan) of high static pressure can be used. Fan cover 40 and first duct 41 can be formed integrally. Grease or a sheet having high heat conductivity can be disposed between DMD 18 and heat sink 30.

### Second Exemplary Embodiment

Next, the second exemplary embodiment of the present invention will be described. The basic configuration of a projection display device according to this exemplary embodiment is similar to that of the projection display device of the first exemplary embodiment, and thus repeated description is avoided. The difference between the projection display device according to this exemplary embodiment and the projection display device of the first exemplary embodiment is the fixed structure of sirocco fan 19 and heat sink 30.

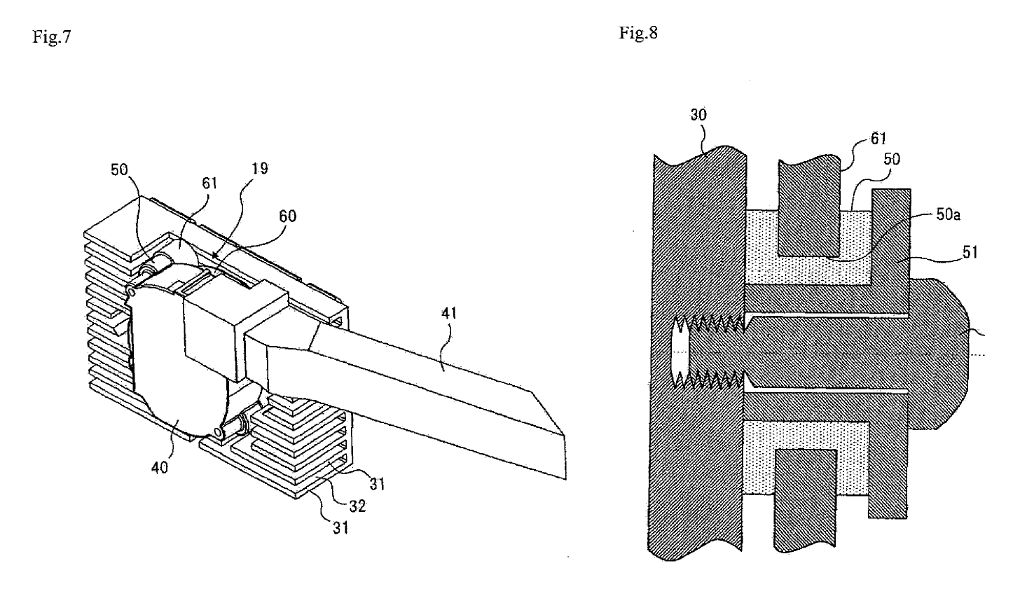

FIGS. 7 and 8 show the fixed structure of sirocco fan 19 and heat sink 30. As shown, vibration absorption member 50 is disposed between sirocco fan 19 and heat sink 30. In this exemplary embodiment, silicon rubber that has rubber hardness of 30 is used as vibration absorption member 50. Vibration absorption member 50 suppresses the propagation of vibrations of sirocco fan 19 to heat sink 30, and thus noise is reduced.

As shown in FIG. 6, housing 60 of sirocco fan 19 includes two attaching portions 61 having through-holes 61a. As shown in FIGS. 7 and 8, vibration absorption member 50 is cylindrical. Further, concave groove 50a is formed all-around on the outer circumference surface of vibration absorption member 50. Vibration absorption member 50 is inserted into through-hole 61a of attaching portion 61, and the edge of through-hole 61a fits in concave groove 50a. When vibration absorption member 50 is inserted into through-hole 61a, vibration absorption member 50 is elastically deformed. Vibration absorption member 50 inserted into through-hole 61a is fixed to through-hole 61a by its own elastic restoration force. Further, as shown in FIG. 8, cylindrical spacer 51 is inserted into vibration absorption member 50, and screw 52 is inserted into spacer 51. The leading end of screw 52 which penetrates spacer 51 is driven into a screw hole formed on the rear surface of heat sink 30. In FIG. 7, stem 40b of fan cover 40 and screw 52 are not shown.

### Third Exemplary Embodiment

Next, the third exemplary embodiment of the present invention will be described. The basic configuration of a projection display device according to this exemplary embodiment is similar to that of the projection display device of the first exemplary embodiment, and thus repeated description is avoided. The projection display device according to this exemplary embodiment includes box-shaped cover 70 that covers heat sink 30 and sirocco fan 19.

Almost entire heat sink 30 is covered with cover 70. Specifically, all the regions of the upper surface, the lower surface and the rear surface of heat sink 30, and almost all the regions of both side faces of heat sink 30 are covered with cover 70. However, a part of both side faces of heat sink 30 is exposed without being covered with cover 70. Further, the side face of heat sink 30 and the side face of cover 70 that face each other are not bonded to each other. In other words, there is a space between the side face of heat sink 30 and the side face of cover 70. Thus, when sirocco fan 19 (FIG. 7) disposed in heat sink 30 rotates, air around heat sink 30 mainly flows from both side faces of heat sink 30 into spaces 32 (FIG. 7) between fins 31 to be sucked by sirocco fan 19. In other words, the flow of the air from the upper surface, the lower surface, and the rear surface of heat sink 30 into spaces 32 is suppressed. As a result, the amount of air that passes through spaces 32 and the contact time of the air that passes through spaces 32 between fins 31 increase, thereby improving the cooling efficiency of heat sink 30.

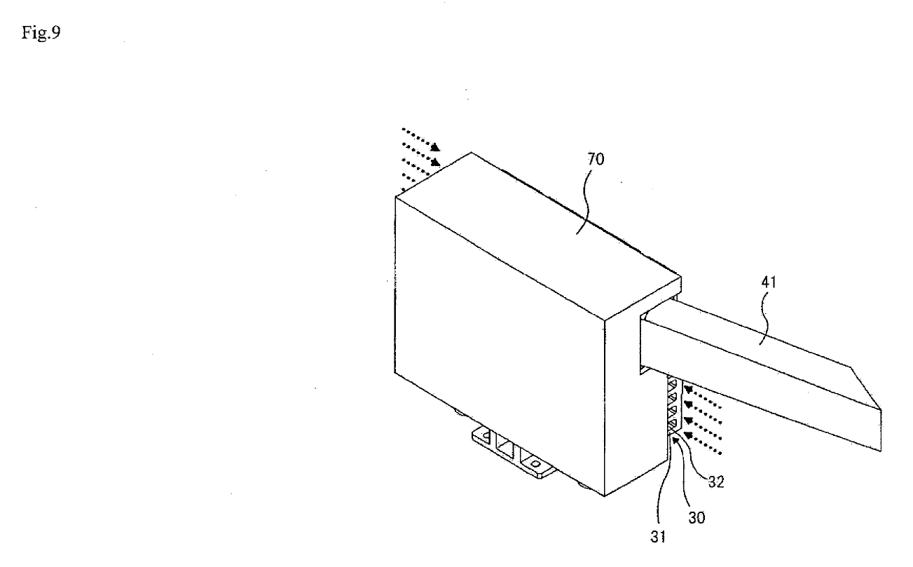

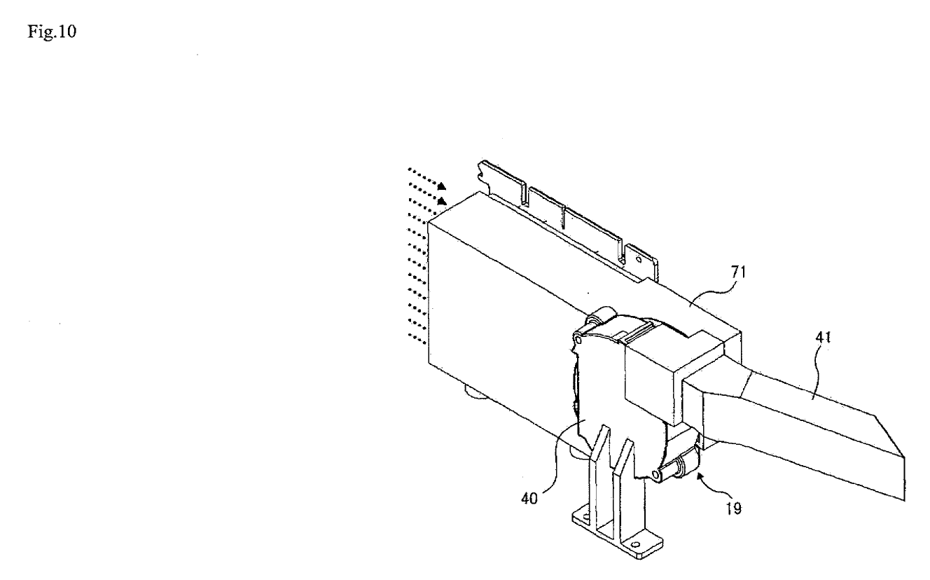

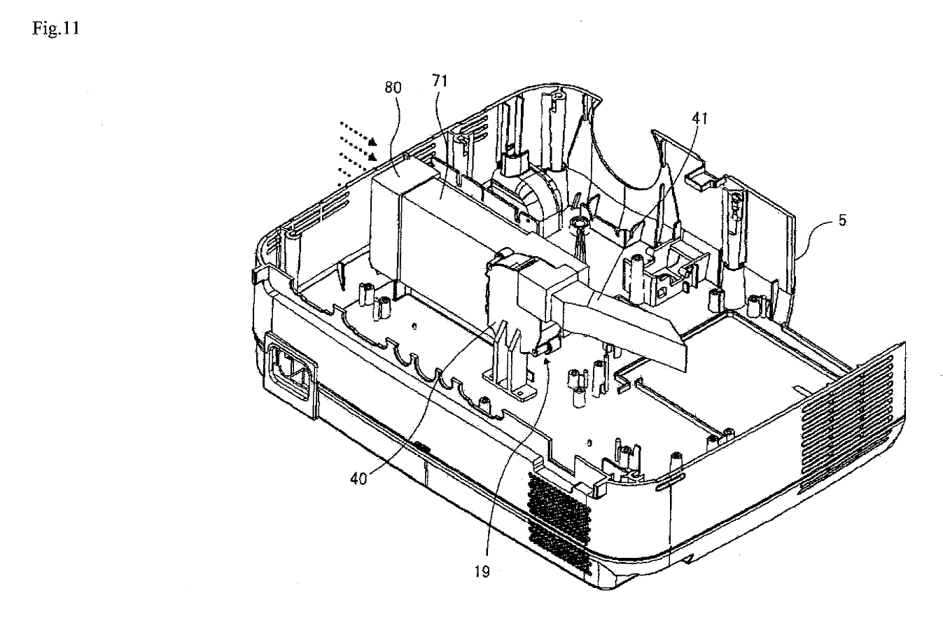

By extending cover 70 shown in FIG. 9 in a longitudinal direction, sirocco fan 19 can be located outside heat sink 30. FIG. 10 shows the embodiment of a cover extended in the longitudinal direction. Shown cover 71 extends in a right direction on a paper surface as compared with cover 70 shown in FIG. 9. All the regions of the upper surface, the lower surface, and the rear surface of the heat sink (not shown) are covered with the cover. Further, the entire region of one (right side face) of the two side faces of the heat sink is covered with cover 71 or fan cover 40. In other words, only the other (left side face) of the two side faces of the heat sink is exposed without being covered with cover 71. Thus, when sirocco fan 19 disposed on the right side of the heat sink rotates, air around the heat sink mainly flows from the left side face of the heat sink into spaces between fins to be sucked by sirocco fan 19. In other words, the air is sucked by sirocco fan 19 after passage through all the regions of spaces.

As apparent from the foregoing, cover 71 functions to suppress the flow of air from a surface other than the predetermined surface into the spaces (heat sink), and serves as a second duct to guide the air that flowed into the spaces (air that passed through the heat sink) to the sirocco fan.

As shown in FIG. 11, third duct 80 that connects the left side face of the heat sink (not shown) not covered with cover 71 to suction port 10b (FIG. 1) disposed in case 5 can be provided. Needless to say, the left side face of the heat sink can be connected to suction port 10a or suction port 10c shown in FIG. 1. In any case, the temperature of the air outside case 5 is lower by 5 to 10° C. than that of the air in case 5. Thus, the structure shown in FIG. 11 enables supplying of the air that has a lower temperature to the heat sink. First duct 41, second duct 80, and fan cover 40 can be formed integrally. The heat sinks in other exemplary embodiments described above can be connected to the suction ports by the ducts.

### REFERENCE NUMERALS

1 Projection display device
5 Case
10 Suction port
15 Lamp unit
15a Lamp
18 DMD
19 Sirocco fan
30 Heat sink
31 Fin
32 Space
40 First duct
50 Vibration absorption member
80 Second duct

1. A projection display device comprising:
a heat sink including a plurality of fins on a rear surface side of the heat sink;
a video device disposed on a front surface side of the heat sink to be thermally connected to the heat sink, and modulating light emitted from a light source;
a centrifugal fan that sucks air through spaces between the plurality of fins included in the heat sink; and
a first duct that guides the air discharged from the centrifugal fan to the light source.

2. The projection display device according to claim 1, wherein a concave portion is formed by partially retracting an end surface of each fin in the heat sink, and the centrifugal fin is received in the concave portion.

3. The projection display device according to claim 1, wherein the centrifugal fan is located outside the heat sink, and the air that passed through the spaces is sucked by the centrifugal fan via a second duct.

4. The projection display device according to claim 1, further comprising a cover to suppress flowing of air from a surface other than a side face of the heat sink into the spaces.

5. The projection display device according to claim 4, further comprising: a case that houses the light source, the video device, the heat sink, the centrifugal fan and the first duct; and a third duct that connects a suction port formed in the case to the side face of the heat sink.

6. The projection display device according to claim 1, wherein the heat sink and the centrifugal fan are fixed via a vibration absorption member.

7. The projection display device according to claim 1, wherein the video device comprises a reflective video device.

8. The projection display device according to claim 5, further comprising: a temperature sensor disposed in the case; a memory that stores data indicating a relationship between a temperature detected by the temperature sensor and the number of revolutions of the centrifugal fan; and a control unit that controls the number of revolutions of the centrifugal fan based on the temperature detected by the temperature sensor and the data stored in the memory.

9. The projection display device according to claim 2, further comprising a cover to suppress flowing of air from a surface other than a side face of the heat sink into the spaces.

10. The projection display device according to claim 3, further comprising a cover to suppress flowing of air from a surface other than a side face of the heat sink into the spaces.

11. The projection display device according to claim 2, wherein the heat sink and the centrifugal fan are fixed via a vibration absorption member.

12. The projection display device according to claim 3, wherein the heat sink and the centrifugal fan are fixed via a vibration absorption member.

13. The projection display device according to claim 4, wherein the heat sink and the centrifugal fan are fixed via a vibration absorption member.

14. The projection display device according to claim 5, wherein the heat sink and the centrifugal fan are fixed via a vibration absorption member.

15. The projection display device according to claim 2, wherein the video device comprises a reflective video device.

16. The projection display device according to claim 3, wherein the video device comprises a reflective video device.

17. The projection display device according to claim 4, wherein the video device comprises a reflective video device.

18. The projection display device according to claim 5, wherein the video device comprises a reflective video device.

19. The projection display device according to claim 6, wherein the video device comprises a reflective video device.
